(19) United States
(12) Patent Application Publication
(10) Pub. No.: US 2025/0312844 A1
(43) Pub. Date: Oct. 9, 2025

(54) IRON-BASED POWDER FOR OXYGEN REACTANT AND OXYGEN REACTANT

(71) Applicant: JFE STEEL CORPORATION, Chiyoda-ku, Tokyo (JP)

(72) Inventors: Naoki YAMAMOTO, Chiyoda-ku, Tokyo (JP); Kohsuke ASHIZUKA, Chiyoda-ku, Tokyo (JP); Shigeru UNAMI, Chiyoda-ku, Tokyo (JP)

(73) Assignee: JFE STEEL CORPORATION, Chiyoda-ku, Tokyo (JP)

(21) Appl. No.: 18/865,681

(22) PCT Filed: Feb. 16, 2023
(86) PCT No.: PCT/JP2023/005559

§ 371 Date: Nov. 14, 2024

(30) Foreign Application Priority Data
Jul. 11, 2022 (JP) 2022-111433

(51) Int. Cl. B22F 1/00; B22F 1/12; B22F 9/22

(52) U.S. Cl. CPC B22F 1/09; B22F 1/12; B22F 9/22; B22F 2301/10; B22F 2301/15; B22F 2301/20; B22F 2301/35; B22F 2302/25

(57) ABSTRACT

Provided is iron-based powder for an oxygen reactant that does not require the use of a metal halide and has excellent oxygen reactivity. The iron-based powder for an oxygen reactant contains iron powder having an atomic number ratio of oxygen to iron, O/Fe, of 0.30 or less, and at least one additive powder selected from the group consisting of copper powder, nickel powder, molybdenum powder, copper oxide powder, nickel oxide powder, and molybdenum oxide powder. The additive powder content is 1.0 mass % or more and 40.0 mass % or less.

### TECHNICAL FIELD

The present disclosure relates to iron-based powder for an oxygen reactant and an oxygen reactant.

### BACKGROUND

Deoxidizing agents and exothermic agents are known example applications of oxygen reactants that utilize the reaction between iron-based powder and oxygen. Deoxidizing agents are sealed in containers along with preserved items such as foods and medicines to keep the preserved items in a low-oxygen state and suppress quality deterioration due to oxidation, mold growth, and the like. Exothermic agents are widely used as a disposable body warmers to warm the human body and the like. Typically, in such oxygen reactants, activated carbon, sodium chloride, silica powder, wood powder, water, sulfur powder, and the like are added to iron-based powder to further promote the oxygen reaction.

Further, in any application where the reaction rate between iron and oxygen is important, mixing iron powder oxide with iron powder has conventionally been considered as a means to control the reaction rate.

For example, JP H05-237373 A (Patent Literature (PTL) 1) describes a deoxidizing agent that has excellent reactivity at low temperatures.

Further, JP S53-60885 A (PTL 2) describes a metal exothermic composition that promotes oxidation by mixing one or more of manganese dioxide, cupric oxide, or iron oxide with activated carbon containing iron powder, chloride, and water.

### CITATION LIST

### Patent Literature

PTL 1: JP H05-237373 A
PTL 2: JP S53-60885 A

### SUMMARY

### Technical Problem

The deoxidizing agent described in PTL 1 requires the use of a metal halide, which easily absorbs moisture from the air and causes oxygen reactions in the iron powder to proceed rapidly. Accordingly, the deoxidizing agent has handling and storage problems, such as the need for storage in a bag for deoxidizing agents immediately after adding the metal halide to the iron powder, and storage under oxygen-free conditions.

In the metal exothermic composition described in PTL 2, iron tetroxide, lead tetroxide, manganese tetroxide, cupric oxide, and manganese dioxide make up the major proportions of the composition, all of which are already oxidized to some extent. Accordingly, the metal exothermic composition has a problem of poor reactivity with oxygen in the early stage of the reaction.

It would be helpful to provide iron-based powder for an oxygen reactant and an oxygen reactant that do not require the use of a metal halide and have excellent oxygen reactivity.

### Solution to Problem

Copper, nickel, and molybdenum have a smaller ionization tendency than iron, and are therefore less likely to react with oxygen than iron. Further, copper oxide, nickel oxide, and molybdenum oxide are already oxidized, and therefore more resistant to reaction with oxygen. Therefore, all of the above substances are inferior to iron powder as oxygen reactants.

In contrast, copper, nickel, and molybdenum have higher standard electrode potentials than iron, and the potential/pH diagram (Pourbaix diagram) for each metal illustrates that the potential increases further as the metal oxidizes.

Here, when iron powder comes into contact with metal powder or the like that has a higher potential than iron powder in a corrosion environment such as electrolyte solution, a local battery mechanism occurs in which corrosion current flows from the high-potential metal powder or the like to the low-potential iron powder, and then returns via the electrolyte solution to the high-potential metal powder or the like, and then flows back to the low-potential iron powder. When such a mechanism occurs, the reaction between the low-potential iron powder and oxygen may be promoted.

In order to promote the reaction between iron-based powder and oxygen, the inventors arrived at the idea of adding the following substances to iron powder and mixing: copper powder, nickel powder, molybdenum powder, and corresponding oxide powders, all of which are less reactive with oxygen than iron and have not been used conventionally, and conducted extensive studies. As a result, the inventors found that there is an appropriate mixing ratio of iron-based powder that exhibits excellent oxygen reactivity.

The present disclosure is based on the above findings and primary features are as follows.
1. Iron-based powder for an oxygen reactant, the iron-based powder comprising:
iron powder having an atomic number ratio of oxygen to iron, O/Fe, of 0.30 or less; and
at least one additive powder selected from the group consisting of copper powder, nickel powder, molybdenum powder, copper oxide powder, nickel oxide powder, and molybdenum oxide powder, wherein
the additive powder content is 1.0 mass % or more and 40.0 mass % or less.
2. An oxygen reactant using the iron-based powder for an oxygen reactant according to 1, above.

### Advantageous Effect

According to the present disclosure, iron-based powder for an oxygen reactant and an oxygen reactant that have excellent oxygen reactivity are obtainable without the need to use a metal halide.

### DETAILED DESCRIPTION

An embodiment of the present disclosure is described below. The following embodiment is an example that is illustrative of the present disclosure, and the present disclosure is not limited to only the described embodiment.

Reasons why the iron-based powder for an oxygen reactant according to the present disclosure exhibits excellent oxygen reactivity are presumed to be as follows. Copper powder, nickel powder, molybdenum powder, and corresponding oxide powders (hereinafter also referred to as “additive powder”) have a higher potential than iron powder. Therefore, when the additive powder and the iron powder come into contact in an electrolyte solution, a corrosion current is generated and the oxidation reaction of the iron powder is promoted. The iron-based powder for an oxygen reactant according to the present disclosure has excellent reactivity with oxygen and is therefore suitable for use to make the oxygen reactant according to the present disclosure. Accordingly, the oxygen reactant according to the present disclosure can achieve the same characteristics and effects as the iron-based powder for an oxygen reactant according to the present disclosure.

Here, when iron is oxidized, potential increases. Accordingly, iron powder prior to use as an oxygen reactant should be as unoxidized as possible to facilitate a larger potential difference with the additive powder. This results in a larger corrosion current. Specifically, the atomic number ratio of oxygen to iron (hereinafter also referred to as “O/Fe”) needs to be 0.30 or less. In this O/Fe range, the potential difference with the additive powder becomes large enough to generate an effective amount of corrosion current (sufficient to promote the oxidation reaction of the iron powder) in the electrolyte solution. Therefore, in the present disclosure, O/Fe in the iron powder of the iron-based powder for an oxygen reactant is 0.30 or less. A lower limit of O/Fe is not particularly specified and may be 0, but is preferably about 0.15 for industrial purposes. Further, the value of O/Fe is measurable according to a method described below.

The iron powder used in the present disclosure may be produced by water atomization, gas atomization, pulverization, and oxide reduction methods.

Further, according to the present disclosure, added to such iron powders are one or more powders selected from the group consisting of copper powder, nickel powder, molybdenum powder, copper oxide powder, nickel oxide powder, and molybdenum oxide powder (the group of additive powder).

Copper powder, nickel powder, and molybdenum powder may be produced by water atomization, gas atomization, pulverization, oxide reduction, and electrolysis, or are available as commercial products. Further, copper oxide powder, nickel oxide powder, and molybdenum oxide powder may be made from copper powder, nickel powder, and molybdenum powder produced by the above methods and oxidized by spraying water, salt water, or the like, or are available as commercial products.

Here, the term “iron-based powder” refers to a metal powder containing 50.0 mass % or more metallic iron. Further, in addition to the metallic iron (Fe), the iron-based powder may further contain any element such as C, S, O, N, Si, Na, Mg, Ca, or the like. The metallic iron content of the iron-based powder is measurable according to the “metallic iron quantification method” in Japanese Industrial Standard JIS A 5011-2.

The iron-based powder for an oxygen reactant is a mixture of iron powder and additive powder, where the additive powder content in the mixture is 1.0 mass % or more and 40.0 mass % or less. When the additive powder content in the iron-based powder for an oxygen reactant is less than 1.0 mass %, the amount of corrosion current is low and the effect of promoting the reaction of iron powder with oxygen is poor. On the other hand, the additive powder itself is less oxidizable and reacts less with oxygen than the iron powder, and therefore when the additive powder content in the iron-based powder for an oxygen reactant is greater than 40.0 mass %, the oxygen reaction volume of the mixture of the iron powder and the additive powder becomes lower than that of the iron powder alone. From the viewpoint of oxygen reactivity, the additive powder content in the iron-based powder for an oxygen reactant is preferably 2.0 mass % or more. The additive powder content is preferably 25.0 mass % or less.

According to the above, the present disclosure provides the iron-based powder for an oxygen reactant that meets the requirements described above to achieve excellent oxygen reactivity.

The particle size of the iron powder and the additive powder is not particularly limited as long as no handling problems are caused. The particle size in median size (median particle size from cumulative volume frequency) D₅₀ is preferably 1 mm or less. D₅₀ is more preferably 400 μm or less. D₅₀ is even more preferably 200 μm or less. On the other hand, a lower limit of the particle size of the iron powder and the additive powder is preferably about 5 μm in terms of handling.

According to the present disclosure, the method for measuring the median size D₅₀ of the iron powder and the additive powder is as follows. The iron powder and the additive powder to be measured are put into ethanol as a solvent, dispersed by ultrasonic oscillation for 30 s or longer, and the particle size is measured by a laser diffraction and scattering method using a laser diffraction particle size distribution analyzer. That is, volume-based particle size distribution of particles of the iron powder and the additive powder are respectively measured. The cumulative particle size distribution is calculated from the particle size distribution obtained, and the particle size corresponding to 50% of the sum of the volume of all particles is determined as the median size D_{50.} According to the present disclosure, the median size D₅₀ is used as a representative value for the particle size of the iron powder and the additive powder, respectively.

### Method of Calculating O/Fe in Powder

According to the present disclosure, the method of calculating O/Fe in powder is preferably as follows. A target powder is measured by X-ray diffraction, and obtained diffraction data is analyzed by Rietveld analysis to determine the content of Fe alone, compounds of Fe and O, and other compounds in the powder. The number of Fe and O atoms can be determined from such content values, and therefore the value of O/Fe can be calculated.

### Production of Iron Powder

The iron powder used according to the present disclosure is preferably prepared by a water atomizing method or gas atomization, in which water or gas is sprayed onto molten metal, which is then pulverized, cooled and solidified; or by reducing iron oxide (mill scale) generated on steel sheet surfaces during hot rolling of steel material; or by reducing iron ore powder. Further, the prepared powder may be classified and selected or mixed in various ways to adjust into the iron powder according to the present disclosure. To remove oxygen to achieve the O/Fe range described above, deoxidation may be performed at 750° C. or more using carbon such as coke or graphite or hydrogen gas.

### Production of Additive Powder (Copper Powder, Nickel Powder, Molybdenum Powder, and Corresponding Metal Oxide Powders)

In production of the copper powder, nickel powder, and molybdenum powder for use according to the present disclosure, a water atomizing method or gas atomization may be used, in which water or gas is sprayed onto molten metal, which is then pulverized, cooled and solidified; or pulverization or oxide reduction methods may be used; but electrolytic powder precipitation on a cathode by electrolysis is particularly preferred. Each metal powder and corresponding oxidized powder may be produced by adjusting the amount of oxygen in the atmosphere during drying. Further, the prepared powder may be classified and selected or mixed in various ways to adjust into the additive powder according to the present disclosure.

### Production of Iron-Based Powder

In the production of the iron-based powder for an oxygen reactant, the iron powder and the additive powder need to be mixed until uniform. Therefore, it is preferable to use a mixing device such as a V-shaped mixer, a double cone mixer, or a conical blender. The above devices and associated mixing conditions may be used according to a conventional method.

### Oxygen Reactant

According to the present disclosure, the iron-based powder for an oxygen reactant may be used to make an oxygen reactant. For example, when the iron-based powder for an oxygen reactant is sealed in a bag described below, the iron-based powder for an oxygen reactant can be made into the oxygen reactant according to the present disclosure. In the oxygen reactant, components other than the iron-based powder for an oxygen reactant can be used without particular restriction as long as they are used in conventionally known oxygen reactants. Examples of such components include a bag of air-permeable packaging material made of non-woven fabric and open-pore polyethylene overlaid, or a bag of air-permeable packaging material made of paper and open-pore polyethylene overlaid.

### EXAMPLES

The iron-based powders for an oxygen reactant used in the present examples were prepared by the following procedure. Thirty-six different iron powders with different O/Fe were prepared by hydrogen reduction of iron ore powder. Separately, additive powders were prepared under various drying conditions using a water atomizing method. Each of the iron powders and additive powders were then mixed in a V-shaped mixer to prepare the iron-based powders for an oxygen reactant. The O/Fe of the iron powders was calculated by measuring the content of Fe alone, compounds of Fe and O, and other compounds with an X-ray diffractometer (SmartLab, produced by Rigaku Holdings Corporation).

For the present examples, an oxygen reactivity evaluation of the iron-based powder for an oxygen reactant was performed as follows. To obtain each oxygen reactant, 0.6 g of an aqueous solution with a sodium chloride concentration of 12 mass % was added to a mixed powder of 1.5 g of zeolite (Zeofill 1424 #, particle size 1.0 mm to 2.0 mm, produced by Shin Tohoku Chemical Industry Co., Ltd.) and 0.1 g of activated carbon powder (particle size 3.0 μm to 300 μm, produced by Fujifilm Wako Pure Chemical Corporation), then 1.5 g of the iron-based powder for an oxygen reactant was added to the mixture and filled into a bag of an air-permeable packaging material (length 50 mm×width 60 mm). A layered material consisting of non-woven fabric and open-pore polyethylene was used for the air-permeable packaging material. One of each oxygen reactant was sealed, along with 3 L of air, in a gas barrier bag of layered material consisting of nylon/aluminum foil/polyethylene. After the bags were left at 25° C. for 8 h, the oxygen concentration in the bags was measured using a gas chromatograph (GD3210D, produced by GL Sciences Inc.). The oxygen reaction volume was calculated from the difference between the measured oxygen concentration and the oxygen concentration in air, and the oxygen reaction volume per 1 g of the iron-based powder for an oxygen reactant was calculated.

Table 1 lists the results of oxygen reaction volume of the iron-based powders for an oxygen reactant according to each Comparative Example and each Example according to the present disclosure.

TABLE 1

| | Iron-based powder | | | | | | | | Evaluation |
|---|---|---|---|---|---|---|---|---|---|
| | Iron powder | Additive powder | | | | | | | result |
| | Oxygen to | | | | Copper | Nickel | | Additive | Oxygen |
| | iron atomic | Copper | Nickel | Molybdenum | oxide | oxide | Molybdenum | powder | reaction |
| | number ratio | powder | powder | powder | powder | powder | oxide powder | total | volume |
| Test No. | O/Fe (—) | (mass %) | (mass %) | (mass %) | (mass %) | (mass %) | (mass %) | (mass %) | (mL/g) |
| Comparative Example 1 | 0.02 | — | — | — | — | — | — | 0.0 | 58 |
| Comparative Example 2 | 0.31 | 2.3 | — | — | — | — | — | 2.3 | 52 |
| Comparative Example 3 | 0.32 | 38.2 | — | — | — | — | — | 38.2 | 53 |
| Comparative Example 4 | 0.02 | 0.8 | — | — | — | — | — | 0.8 | 50 |
| Comparative Example 5 | 0.05 | 40.4 | — | — | — | — | — | 40.4 | 51 |
| Comparative Example 6 | 0.34 | — | 1.8 | — | — | — | — | 1.8 | 55 |
| Comparative Example 7 | 0.50 | — | 36.2 | — | — | — | — | 36.2 | 57 |
| Comparative Example 8 | 0.15 | — | 0.7 | — | — | — | — | 0.7 | 55 |
| Comparative Example 9 | 0.28 | — | 40.8 | — | — | — | — | 40.8 | 50 |
| Comparative Example 10 | 0.45 | — | — | 1.5 | — | — | — | 1.5 | 50 |
| Comparative Example 11 | 0.50 | — | — | 39.3 | — | — | — | 39.3 | 52 |
| Comparative Example 12 | 0.04 | — | — | 0.8 | — | — | — | 0.8 | 54 |
| Comparative Example 13 | 0.01 | — | — | 41.0 | — | — | — | 41.0 | 56 |
| Comparative Example 14 | 0.44 | — | — | — | 1.5 | — | — | 1.5 | 55 |
| Comparative Example 15 | 0.46 | — | — | — | 38.8 | — | — | 38.8 | 58 |
| Comparative Example 16 | 0.29 | — | — | — | 0.5 | — | — | 0.5 | 56 |
| Comparative Example 17 | 0.02 | — | — | — | 41.4 | — | — | 41.4 | 55 |
| Comparative Example 18 | 0.32 | 0.5 | 0.5 | 0.7 | — | — | — | 1.7 | 51 |
| Comparative Example 19 | 0.34 | 15.6 | 20.2 | 3.1 | — | — | — | 38.9 | 53 |
| Comparative Example 20 | 0.10 | 0.4 | 0.3 | 0.2 | — | — | — | 0.9 | 58 |
| Comparative Example 21 | 0.03 | 21.7 | 18.1 | 1.5 | — | — | — | 41.3 | 57 |
| Comparative Example 22 | 0.32 | 0.7 | 2.1 | — | 0.2 | — | 0.6 | 3.6 | 56 |
| Comparative Example 23 | 0.34 | 10.3 | 8.8 | — | 12.3 | — | 6.3 | 37.7 | 56 |
| Comparative Example 24 | 0.09 | 0.2 | 0.2 | — | 0.2 | — | 0.2 | 0.8 | 57 |
| Comparative Example 25 | 0.30 | 8.2 | 4.2 | — | 10.8 | — | 18.3 | 41.5 | 55 |
| Comparative Example 26 | 0.35 | 0.3 | 0.2 | 0.1 | 0.5 | 0.1 | 0.2 | 1.4 | 58 |
| Comparative Example 27 | 0.40 | 8.6 | 2.3 | 6.1 | 5.8 | 10.2 | 6.3 | 39.3 | 58 |
| Comparative Example 28 | 0.02 | 0.1 | 0.2 | 0.2 | 0.1 | 0.1 | 0.2 | 0.9 | 56 |
| Comparative Example 29 | 0.29 | 5.2 | 2.0 | 5.1 | 2.3 | 7.2 | 18.3 | 40.1 | 57 |
| Example 1 | 0.02 | 1.2 | — | — | — | — | — | 1.2 | 64 |
| Example 2 | 0.06 | — | 39.7 | — | — | — | — | 39.7 | 65 |
| Example 3 | 0.04 | — | — | 25.8 | — | — | — | 25.8 | 68 |
| Example 4 | 0.26 | — | — | — | 2.5 | — | — | 2.5 | 71 |
| Example 5 | 0.03 | 4.5 | 11.6 | 8.6 | — | — | — | 24.7 | 74 |
| Example 6 | 0.18 | 5.5 | 2.3 | — | 11.2 | — | 5.8 | 24.8 | 78 |
| Example 7 | 0.30 | 0.3 | 1.2 | 0.3 | 0.1 | 0.2 | 0.3 | 2.4 | 79 |

* Underlining indicates value outside scope of present disclosure.

As listed in Table 1, the oxygen reaction volumes of the iron-based powders for an oxygen reactant of Examples 1 to 7, in which the atomic number ratio of oxygen to iron in the iron powder, O/Fe, is 0.30 or more and the additive powder content in the mixed powder of the iron powder and the additive powder is 1.0 mass % or more and 40.0 mass % or less, are greater than that of the iron-based powders for an oxygen reactant of Comparative Examples 1 to 29. Further, the oxygen reaction volumes per 1 g of the iron-based powders for an oxygen reactant are 60 mL/g or more, indicating excellent oxygen reaction volume and excellent oxygen reactivity.

Among these, Examples 4 and 7, in which the additive powder content is 2.0 mass % or more, and Examples 5 and 6, in which the additive powder content is 25.0 mass % or less, are superior, as the oxygen reaction volume per 1 g of the iron-based powder for an oxygen reactant is 70 mL/g or more in each case.

1. Iron-based powder for an oxygen reactant, the iron-based powder comprising:
iron powder having an atomic number ratio of oxygen to iron, O/Fe, of 0.30 or less; and
at least one additive powder selected from the group consisting of copper powder, nickel powder, molybdenum powder, copper oxide powder, nickel oxide powder, and molybdenum oxide powder, wherein
the additive powder content is 1.0 mass % or more and 40.0 mass % or less.

2. An oxygen reactant using the iron-based powder for an oxygen reactant according to claim 1.
